(19) United States
(12) Patent Application Publication
(10) Pub. No.: US 2008/0309074 A1
(43) Pub. Date: Dec. 18, 2008

(54) DEVICE FOR CONNECTION OF A TUBE TO A STRUCTURE

(75) Inventor: Juan Carlos OLANO JAUREGUI, LEGORRETA (Gipuzkoa) (ES)

Correspondence Address: LUCAS & MERCANTI, LLP, 475 PARK AVENUE SOUTH, 15TH FLOOR, NEW YORK, NY, 10016, US

(73) Assignee: EREDU, S. Coop, Legorreta (Gipuzkoa) (ES)

(21) Appl. No.: 11/940,873

(22) Filed: Nov. 15, 2007

(30) Foreign Application Priority Data
Jun. 12, 2007 (ES) P200701619

(51) Int. Cl. F16L 33/00

(52) U.S. Cl. 285/255

(57) ABSTRACT

A device for connection of a tube to a structure, which consists of an expandable female plug (1) whose outer surface is, at least partially, in contact with the inner surface of the tube (2), the female plug (1) having an orifice (4) in which a moveable male plug (3) is located whose outer surface (8) combines at least partially with the surface (7) of the orifice (4) in the manner of a wedge, having means of tightening by screws (5) to join the male plug (3) to the structure (6) through the female plug (1) with which the tube (2) is joined to the structure (6).

There are a vast number of known tubular connection devices.

The object of the invention is to achieve a device with few elements, made of cheap materials, easily assembled and used, and absolutely reversible, so that assembly and dismantling does not require great expertise.

It is, therefore, a device which achieves the required features both easily and cheaply.

Moreover, given the deformability of its elements, a clear improvement in the desired tightness/connection is obtained.

Specifically, the “device for connection of a tube to a structure” of this invention is characterized by consisting of an expandable female plug with an outer surface which is, at least partially, in contact with the inner surface of the tube, the female plug having an orifice in which a moveable male plug whose outer surface combines at least partially with the surface of the orifice in the manner of a wedge and having the means of tightening by screws to join the male plug to the structure through the female plug with which the tube is joined to the structure.

Another characteristic of this device is that the surface of the orifice is truncated pyramidal or truncated conical.

An additional characteristic is that the female plug consists of an upper extension which is deformable against the structure.

It is also characterized by the orifice of the female plug being extended from outside by slots.

Finally, a characteristic is that the structure consists of an outer-surface pin combined with the inner surface of the tube which it clamps at the connection and in which the tightening means are screwed.

To better understand the object of this invention, the figures represent a preferred way to its practical application, subject to additional changes which do not change its fundamentals.

FIG. 1 is a cross-sectional view of the elements in explosion of a practical use of the invention.

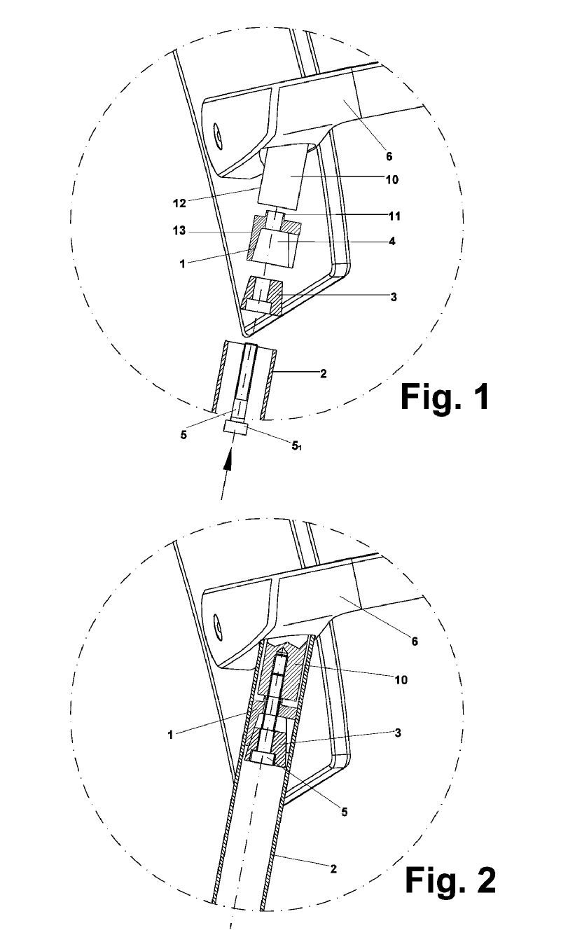

FIG. 2 is a cross-sectional view of the elements combined in FIG. 1.

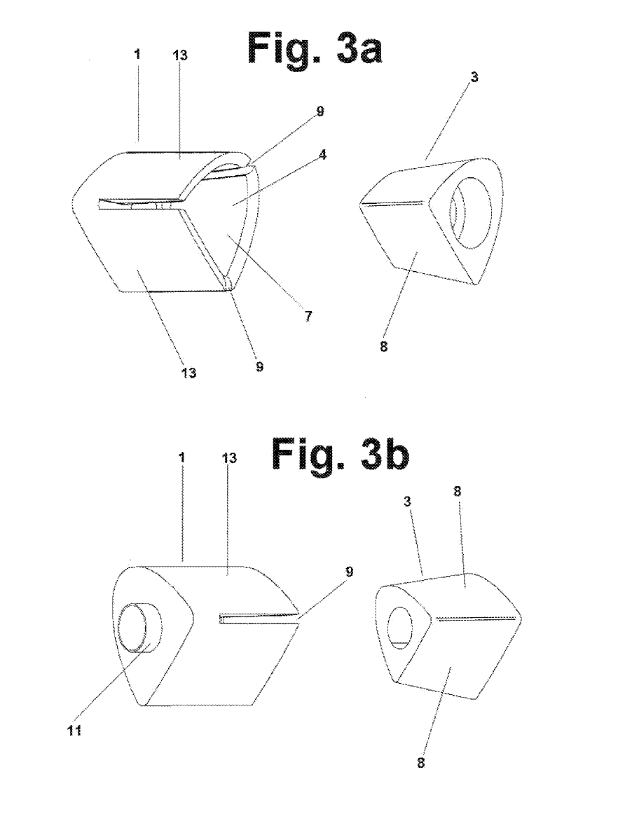

FIGS. 3a and 3b are seen from the perspective of the male plug (3) and a female plug (1) in explosion of FIG. 1.

The following is a description of an example of applying this invention in a practical, non-limiting way.

In the application of FIG. 1 a back-arm joint of a chair is represented as a structure (6) and the leg of a chair as a tube (2) but the device of this invention is equally applicable to any other type of structure/tube.

There is a female plug (1), preferably of deformable material such as a plastic or polymer in which at least a part of the outside surface (13) will be secured by expansion in tightening/deformation against the inner wall of the tube (2).

The female plug (1), for said expansion, has lateral slots (9) in communication with an orifice (4).

There is also a male plug (3) which is placed so as to move lengthwise inside the orifice (4) of the female plug (1).

The wall/outer surface (8) of the male plug (3) combines with the wall/inner surface (7) of the female plug (1) so that on moving within, the walls of the male plug (3) press upon the inner surface (7) of the female plug (1) so that they can expand because of the slots (9) and tighten against the inner wall of the tube (2).

The tube combination (2) female plug (1)-male plug (3) has been effected in the example, the orifice (4) of the female plug (1) and the surface of the male plug (3) having a truncated conical or truncated pyramidal structure, but it can be of another type as long as it achieves lateral pressure when the male plug moves (3).

There is a screw (5) which, penetrating the male plug (3) and the female plug, (1) becomes joined to the structure (6), the head (5₁) of the screw (5) pushing upon the base of the male plug (3).

Preferably, as in FIGS. 1 and 2, the structure (6) has a pin (10) whose outer surface (12) is combined with the inner surface of the tube (2) which will clamp it once the joint is made.

In order to improve the joint, on the head of the female plug (1) there is at least one deformable extension (1 1) which allows a better fit/tightening of the female plug (1) in the tube (2). Even after the head of the female plug (1) tightens against the structure (6) and in this case against the pin (10), it continues to act upon the screw (5) thus increasing the traction upon the pin (10) and the stress between said pin (10) and the female plug (1), it being possible for the female plug (1) to continue advancing/expanding and thus improving the overall joint/tightness, due to the deformation through crushing of the extension (11).

1. A device for connection of a tube to a structure, comprising: an expandable female plug with an outer surface that is, at least partially, in contact with the inner surface of the tube, the female plug having an orifice in which a moveable male plug whose outer surface combines at least partially with the surface of the orifice in the manner of a wedge and having a means of tightening by screws to join the male plug to the structure through the female plug with which the tube is joined to the structure.

2. The device for connection of a tube to a structure, according to claim 1, wherein the surface of the orifice is truncated pyramidal or truncated conical.

3. The device for connection of a tube to a structure, according to claim 1, wherein the female plug further comprises an upper extension which is deformable against the structure.

4. The device for connection of a tube to a structure, according to claim 1, wherein the orifice of the female plug is extended from outside by slots.

5. The device for connection of a tube to a structure, according to claim 1, wherein the structure further comprises a pin on the outer surface combined with the inner surface of the tube on which the tightening means are screwed.
